(19) United States
(12) Patent Application Publication
(10) Pub. No.: US 2014/0173925 A1
(43) Pub. Date: Jun. 26, 2014

(54) ARC-CUTTING MECHANISM AND METHOD OF USE

(71) Applicant: Circle Boss, LLC, Arlington, TX (US)

(72) Inventor: Bobby Eugene Merrill, Fort Worth, TX (US)

(21) Appl. No.: 13/904,036

(22) Filed: May 29, 2013

Related U.S. Application Data
(60) Provisional application No. 61/652,645, filed on May 29, 2012.

(51) Int. Cl. B23Q 3/00

(52) U.S. Cl. CPC B23Q 3/005
USPC 33/568

(57) ABSTRACT

An apparatus and method for efficient cutting and shaping of radiused cuts in materials. The apparatus provides a lower pivot shaft base secured to a cutting table and an upper pivot bushing secured to a workpiece. The lower pivot shaft base and upper pivot are shaped and sized to mate with one another, thus fixing the position of the workpiece while allowing rotation about a common axis.

### CROSS-REFERENCES TO RELATED APPLICATIONS

This application takes priority from provisional patent application No. 61/652,645 filed by Bob Merrill on May 29, 2012.

### TECHNICAL FIELD OF THE INVENTION

The present disclosure relates generally to machining of materials, and particularly to a simple and useful mechanism for facilitating the same.

### BACKGROUND OF THE INVENTION

It is not uncommon for professionals and hobbyists alike to employ useful guides and mechanisms in order to improve the quality of cuts and patterns. This is particularly true in connection with powered woodworking and metalworking tools.

### SUMMARY OF THE INVENTION

The present disclosure provides a versatile apparatus for cutting an arc in a workpiece.

The apparatus and method disclosed herein facilitates simple and easy machining, contouring and cutting of a workpiece along an arc having a radius set by the woodworker or machinist. In general, the apparatus comprises an upper female bushing securable to the workpiece and a lower shaft mated to the upper bushing and securable to a machine table surface.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 depicts an oblique view of an arc cutting apparatus according to certain embodiments;

FIG. 2 depicts a side view of the apparatus;

FIG. 3 depicts a top view of the apparatus;

FIG. 4 depicts an exploded detail view of the pivot bushing and shaft assembly shown in FIGS. 1-3; and

FIG. 5 is a flowchart showing a method of use of the apparatus of FIGS. 1-4.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

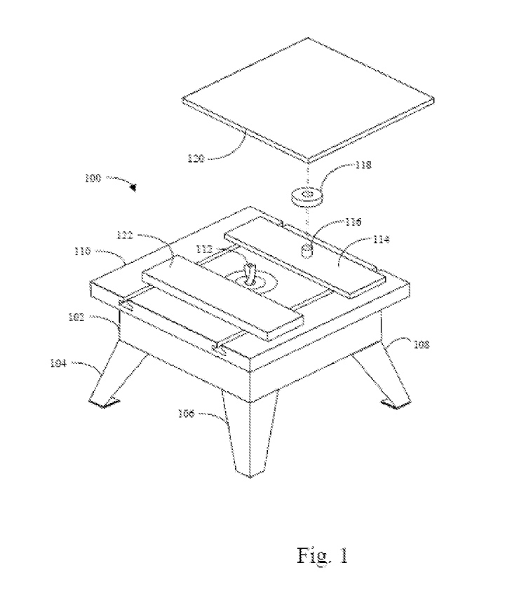

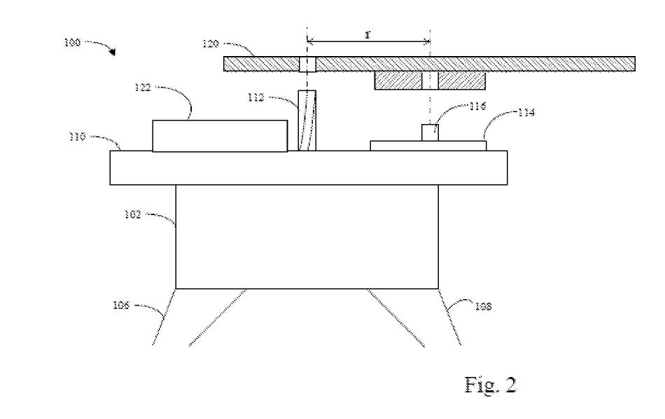

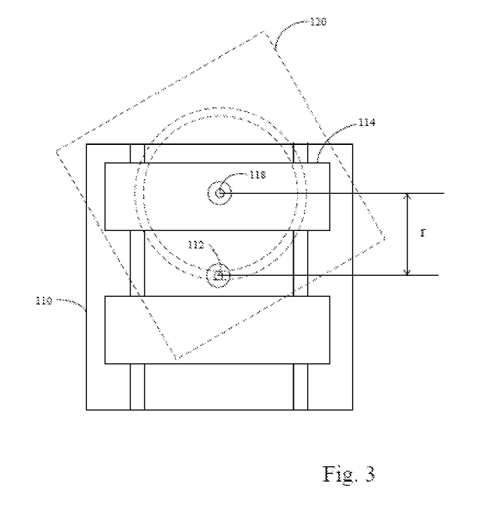

FIGS. 1-4 depict views of an arc-cutting apparatus 100 suitable for machining of a workpiece. Arc-cutting apparatus 100 comprises a cutting machine 102 having a table surface 110 vertically supported by legs 104, 106, 108. In the center of the table surface 110, a cutting tool end 112 protrudes vertically, in order to cut a workpiece at a predetermined depth.

A pivot shaft base 114 having a pivot shaft 116 disposed therein is secured along an edge of the table surface 110 adjacent to cutting tool end 112. A female upper pivot bushing 118 mates to pivot shaft 116, thereby fixing the position of female upper pivot bushing 118 while allowing it to rotate about the central axis of pivot shaft 116. Workpiece 120 is, in turn, secured to female upper pivot bushing 118, thereby fixing the position of workpiece 120 while allowing it to rotate with the upper pivot bushing 118 about the central axis of pivot shaft 116.

In the embodiment shown in FIGS. 1-4, a workpiece support 122 is disposed along the edge of table surface 110 opposite cutting tool end 112 from pivot shaft base 114, in order to support the outboard edge of workpiece 120. Those of skill in the art will recognize that other similar structures may, in certain embodiments, be employed for the same or similar purposes.

Those of skill in the art will recognize that the specific machine depicted in FIGS. 1-3 is a router-type tool having a rotary cutting tool extending upwardly. There is nothing within the spirit and scope of the present disclosure limiting its use to such a device. The teachings of the present disclosure could readily be employed in connection with a wide variety of tools, including but not limited to vertical mills, drill presses, table saws, band saws and radial arm saws, as examples.

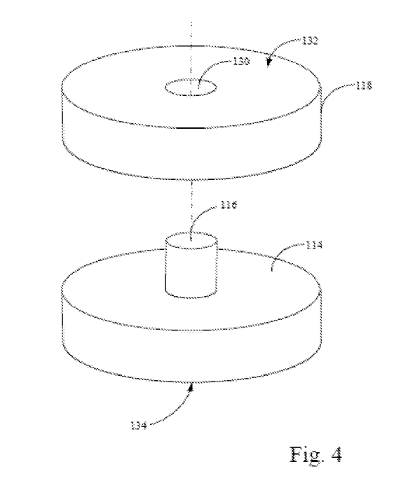

FIG. 4 depicts a detailed exploded oblique view of a pivot shaft base 114 and female upper pivot bushing 118. It can be seen in this figure that pivot shaft 116 has a generally-cylindrical shape. The interior profile of pivot bushing 118 has a size and shape to mate with the generally-cylindrical shape of pivot shaft 116, thereby allowing the positions of the two to be fixed together when mated, while allowing for rotation about the principal axis of pivot shaft 116.

Pivot shaft base 114, pivot shaft 116 and female upper pivot bushing 118 may be made of any material having suitable strength and rigidity to fix a workpiece in place while allowing it to rotate. Those of skill in the art will recognize that such materials may include, but are not limited to, polymers, wood, aluminum, steel or any suitable combination thereof. In one embodiment of the present disclosure, provided solely by way of an example, pivot shaft base 114 and upper pivot bushing 118 are made of acrylic polymer and pivot shaft 116 is made of steel.

According to certain embodiments of the present invention, upper surface 132 of female upper pivot bushing 118 is secured directly to the workpiece 120 by some securement mechanism, which may include double-sided adhesive tape, liquid adhesive, mechanical fasteners, clamps or magnetism, as examples. Similarly, lower surface 134 of pivot shaft base 114 is secured to the upper table surface 110 by a securement mechanism, which may include any one or of the above, or any other securement mechanism known to those of skill in the art.

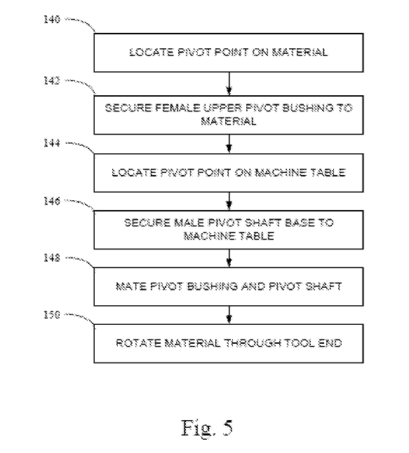

FIG. 5 depicts a flowchart of a method of use of the arc cutting mechanism described above. According to the method, a pivot point is located (140) on the workpiece and the female upper pivot bushing is secured (142) to the workpiece about the pivot point. A pivot point is located (144) on the machine table surface and the male pivot shaft base is then secured (146) to the machine table about the pivot point. The upper pivot bushing and pivot shaft are mated (148) and the workpiece is rotated (150) through the cutting tool end about a pivot axis defined by the pivot points.

Similar embellishments, and various combinations thereof, are all comprehended by the present disclosure. In fact, all embodiments described herein are presented for purposes of illustration and explanation only. The specific compositions, configurations, orientations and operations of various features, portions and members may be provided in a number of ways in accordance with the present disclosure.

Although certain functionalities may have been represented herein by a single component for the sake of simplicity, those of skill in the art will recognize that the functions of a single component may be performed by multiple separate components in certain embodiments. Thus, the embodiments and examples set forth herein are presented to best explain the present disclosure and its practical application and to thereby enable those skilled in the art to make and utilize the disclosure.

As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

What is claimed is:

1. An arc-cutting guide comprising:
a pivot shaft base;
a pivot shaft, secured to the pivot shaft base;
a female pivot bushing, shaped and sized to mate with the pivot shaft.

2. The arc-cutting guide of claim 1, wherein the female pivot bushing is cylindrical.

3. The arc-cutting guide of claim 1, wherein the pivot shaft base is cylindrical.

4. The arc cutting guide of claim 1, wherein the pivot shaft base is readily-securable to a table surface.

5. The arc-cutting guide of claim 1, wherein the female pivot bushing is readily-securable to a workpiece.

6. The arc-cutting guide of claim 1, wherein the pivot bushing comprises an adhesive on an upper surface thereof.

7. The arc-cutting guide of claim 1, wherein the pivot shaft base comprises an adhesive on a lower surface thereof.
